(19) United States
(12) Patent Application Publication
(10) Pub. No.: US 2024/0233994 A1
(43) Pub. Date: Jul. 11, 2024

(54) SKELETONLESS WINDING AND MAGNETIC ASSEMBLY

(71) Applicant: Aplus Power Technology (Hangzhou) Co., Ltd., Hangzhou (CN)

(72) Inventors: Tianding HONG, Hangzhou (CN); Changyun XIAO, Hangzhou (CN)

(21) Appl. No.: 18/542,702

(22) Filed: Dec. 17, 2023

(30) Foreign Application Priority Data
Jan. 9, 2023 (CN) 202310028577.2

(51) Int. Cl. H01F 5/04; H01F 27/28; H01F 27/30

(52) U.S. Cl. CPC H01F 5/04; H01F 27/2871; H01F 27/306; H01F 2005/043

(57) ABSTRACT

The present disclosure provides a skeletonless winding. The skeletonless winding includes a first conductive element provided with a first through hole, a second conductive member provided with a second through hole that is connected with the first through hole to form a through hole, and a resisting part. The resisting part is fixedly connected between the first conductive element and the second conductive element to form a cavity between the first conductive element and the second conductive element.

### CROSS-REFERENCE TO RELATED APPLICATION

This application claims priority to and the benefit of Chinese Patent Application No. 202310028577.2, filed on Jan. 9, 2023, the disclosure of which is incorporated herein by reference in its entirety.

### TECHNICAL FIELD

The present disclosure relates to technologies of electronic components, and in particular, to skeletonless windings and magnetic assemblies.

### BACKGROUND

Generally, a server power supply with low-voltage output, due to a large current of a secondary winding of the transformer, may adopt multiple sets of copper sheets Q that are connected in parallel as shown in FIG. 1 and FIG. 2 to improve current transmission capacity of the secondary winding. A primary winding of the transformer adopts a winding structure and is wound on a skeleton B. The skeleton is also used to fix each of the copper sheets. However, the skeleton in the transformer will reduce winding space of the primary winding, thereby increasing loss of the transformer. Besides, the skeleton has poor thermal conductivity, which affects heat dissipation of the transformer.

### SUMMARY

In view of above, in a first aspect, some embodiments of the present disclosure provides a skeletonless winding, including: a first conductive element provided with a first through hole, a second conductive member provided with a second through hole that is connected with the first through hole to form a through hole, and a resisting part, fixedly connected between the first conductive element and the second conductive element to form a cavity between the first conductive element and the second conductive element.

In a second aspect, some embodiments of the present disclosure further provide a magnetic assembly, including: one or more skeletonless winding as described in the first aspect, a magnetic core assembly comprising one or more winding posts disposed inside the through hole, and one or more winding assemblies wound on an outer peripheral surface of the one or more winding posts in the cavity.

### BRIEF DESCRIPTION OF THE DRAWINGS

Some embodiments of the present disclosure will be described in detail below in connection with the accompanying drawings. The embodiments are described for illustrative purposes only and are not intended to limit the present disclosure.

FIG. 1 is a structural schematic diagram of a magnetic assembly.

FIG. 2 is an exploded view of a magnetic assembly.

FIG. 3 is a schematic structural diagram of a skeletonless winding according to some embodiments of the present disclosure.

FIG. 4 is a schematic structural diagram of a flattened skeletonless winding according to some embodiments of the present disclosure.

FIG. 5 is a schematic structural diagram of a magnetic assembly according to some embodiments of the present disclosure.

FIG. 6 is an exploded view of a magnetic assembly according to some embodiments of the present disclosure.

FIG. 7 is a schematic diagram of a partial structure of a magnetic assembly according to some embodiments of the present disclosure.

FIG. 8 is an exploded view of a part of a magnetic assembly according to some embodiments of the present disclosure.

FIG. 9 is a schematic diagram of a first insulating layer according to some embodiments of the present disclosure.

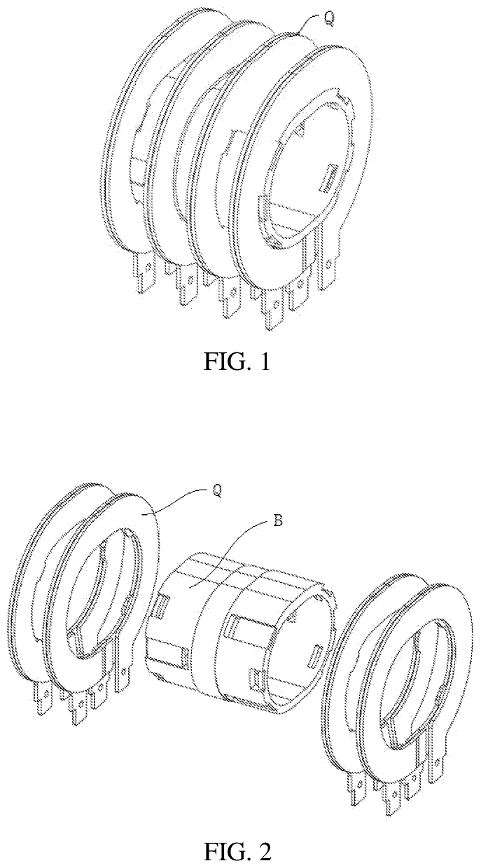

### DETAILED DESCRIPTION

Some embodiments of the present disclosure will be described in detail below in conjunction with the drawings. It should be understood that the described embodiments are only to illustrate and explain the present disclosure, but not intended to limit the present disclosure.

It should be understood that, the terms “include” and “comprise”, when used in this specification and appended claims, specify presence of described features, integers, steps, operations, elements and/or components, but do not exclude presence or addition of one or more other features, integers, steps, operations, elements, components and/or groups thereof.

It should be understood that, the terminology used herein is for the purpose of describing particular embodiments only and is not intended to be limiting. As used herein, the singular forms “a,” “an,” and “the” may be intended to include the plural forms as well, unless the context clearly indicates otherwise.

It should also be further understood that the term “and/or” used in the specification and the appended claims of the present disclosure refers to any combination and all possible combinations of one or more of the associated listed items.

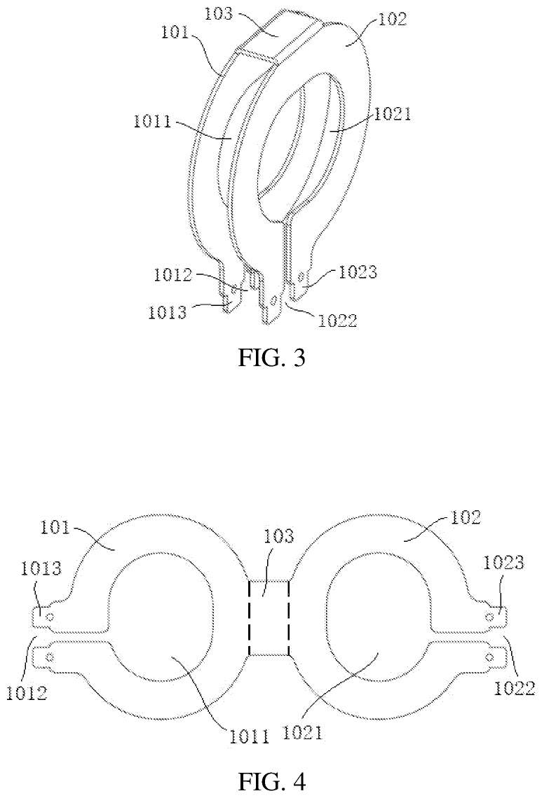

Please refer to FIG. 3 and FIG. 4. FIG. 3 is a schematic structural diagram of a skeletonless winding according to some embodiments of the present disclosure. FIG. 4 is a schematic structural diagram of a flattened skeletonless winding according to some embodiments of the present disclosure. As shown in FIG. 3 and FIG. 4, a skeletonless winding includes a first conductive member 101, a second conductive member 102, and a resisting part 103.

The first conductive member 101 is provided with a first through hole 1011.

The second conductive member 102 is provided with a second through hole 1021. The second through hole 1021 is connected with the first through hole 1011 to form a through hole.

One terminal of the resisting part 103 is fixedly connected to the first conductive element 101 and another terminal of the resisting part 103 is fixedly connected to the second conductive element 102 to form a cavity between the first conductive element 101 and the second conductive element 102.

The first through hole 1011 may be arranged in the middle of the first conductive member 101. The second through hole 1021 may be arranged in the middle of the second conductive member 102. The first conductive member 101 and the second conductive member 102 may be arranged in parallel. The resisting part 103 is used to connect and fix the first conductive member 101 and the second conductive member 102 to form an integrated structure and form a U-shaped cavity between the first conductive member 101 and the second conductive member 102. In this way, when the skeleton winding is applied to a magnetic assembly, coils may be wound around the through hole in the cavity and are limited by the resisting part 103.

In some embodiments, the first conductive member 101 and the second conductive member 102 may be used as secondary windings in a magnetic assembly, and the first conductive member 101 and the second conductive member 102 may be copper sheets. The cavity formed by the first conductive member 101, the second conductive member 102, and the resisting part 103 can directly serve as a cavity for a primary winding in the magnetic assembly.

In some embodiments, as shown in FIG. 4, the first conductive member 101, the second conductive member 102, and the resisting part 103 are integrally formed.

In some embodiments, the first conductive member 101, the second conductive member 102, and the resisting part 103 may be integrally formed by stamping, by welding, or in other ways.

For example, the first conductive member 101, the second conductive member 102, and the resisting part 103 may be integrally formed by stamping, and then the integrated structure may be bent between the first conductive member 101 and the resisting part 103 and between the second conductive member 102 and the resisting part 103, so that the U-shaped cavity is formed between the first conductive member 101 and the second conductive member 102.

In some embodiments, as shown in FIG. 3 and FIG. 4, the first conductive member 101 is further provided with a first opening 1012, and the second conductive member 102 is further provided with a second opening 1022. The first opening 1012 and the first through hole 1011 are connected, and the second opening 1022 and the second through hole 1021 are connected. The first opening 1012 provided on the first conductive member 101 and the second opening 1022 provided on the second conductive member 102 may prevent the magnetic assembly assembled with the skeletonless winding from short circuiting. In addition, the first opening 1012 extends from an outermost circumference of the first conductive member 101 to a bottom of an uppermost end of the first through hole 1011, and the second opening 1022 extends from an outermost circumference of the second conductive member 102 to a bottom of an uppermost end of the second through hole 1021.

In some embodiments, as shown in FIG. 3 and FIG. 4, the first conductive member 101 is further provided with first pins 1013, and the second conductive member 102 is further provided with second pins 1023, the first pins 1013 are located on two sides of the first opening 1012, and the second pins 1023 are located on two sides of the second opening 1022.

For example, the first conductive member 101 may be provided with two first pins 1013, and the two first pins may be respectively located on two sides of the first opening 1012. The second conductive member 102 may be provided with two second pins 1023, and the two second pins 1023 may be respectively located on two sides of the second opening 1022. The first pins 1013 and the second pins 1023 may be used to electrically connect the skeletonless winding and other electronic components.

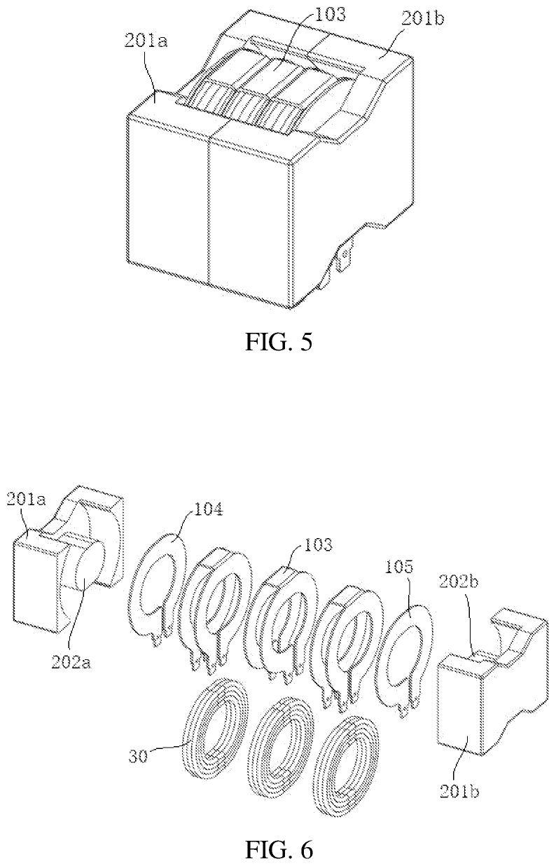

In some embodiments, as shown in FIG. 5 and FIG. 6, some embodiments of the present disclosure further provide a magnetic assembly, which includes: one or more skeletonless windings, a magnetic core assembly, and one or more winding assemblies 30. Each of the one or more skeletonless windings includes a first conductive member 101, a second conductive member 102, a resisting part 103.

The first conductive member 101 is provided with a first through hole 1011.

The second conductive member 102 is provided with a second through hole 1021. The second through hole 1021 is connected with the first through hole 1011 to form a through hole.

One terminal of the resisting part 103 is fixedly connected to the first conductive element 101 and another terminal of the resisting part 103 is fixedly connected to the second conductive element 102 to form a cavity between the first conductive element and the second conductive element.

The magnetic core assembly includes one or more winding posts arranged inside the through hole.

The one or more winding assemblies are wound on an outer peripheral surface of the one or more winding posts in the cavity.

In the embodiments, the skeletonless windings formed by the first conductive member 101, the second conductive member 102, and the resisting part 103 may be used as a secondary winding of the magnetic assembly, and the one or more winding assemblies 30 may be used as a primary winding of the magnetic assembly. In an assembly process of a magnetic component, the one or more winding posts may be directly arranged inside the through hole, and the one or more winding assemblies 30 may be directly wound around an outer circumference of the one or more winding posts in the cavity without setting a skeleton in the magnetic component, which may improve an assembly efficiency of the magnetic component, reduce a volume of the magnetic component, and avoid poor heat dissipation performance of a transformer due to addition of the skeleton.

It should be noted that the magnetic component provided in the embodiments of the present disclosure may be, but not limited to, a transformer, an inductor, or a filter. In addition, the magnetic component provided by the embodiments of the present disclosure may be provided with a plurality of skeletonless windings. The through holes of the plurality of skeletonless windings may be connected. The one or more winding posts in the magnetic core assembly may be directly arranged inside the through holes. The cavity of each of the skeletonless windings may be provided with one winding assembly 30. Each winding assembly 30 may be individually wound on the outer peripheral surface of the one or more winding posts in the corresponding cavity. In addition, the one or more winding assemblies 30 may be directly connected in the cavities and may be limited by the resisting part 103.

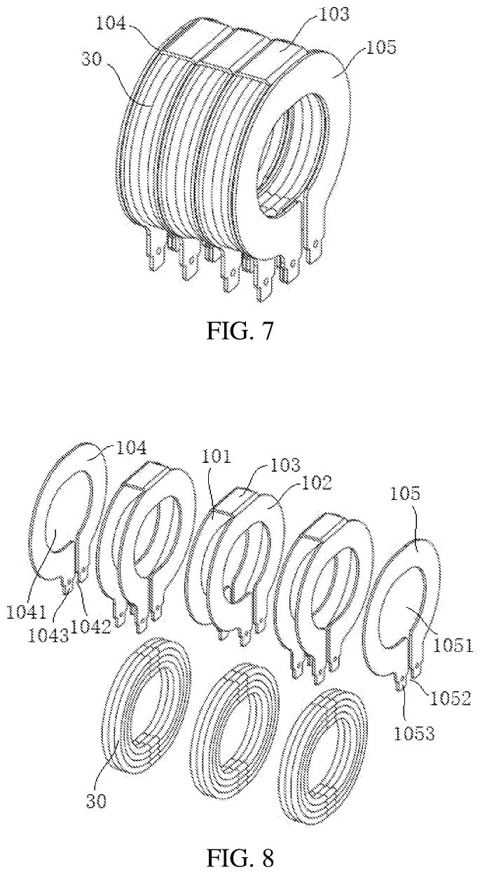

In some embodiments, as shown in FIG. 6, FIG. 7, and FIG. 8. The magnetic assembly may further include a third conductive member 104 and a fourth conductive member 105. The third conductive member 104 is provided with a third through hole 1041, and the fourth conductive member 105 is provided with a fourth through hole 1051. The first through hole 1011 and the second through hole 1021 of each of the one or more skeletonless windings, the third through hole 1041, and the fourth through hole 1051 are connected to form a through hole. The third conductive element 104 and the fourth conductive member 105 are respectively located on two sides of the skeletonless winding.

In some embodiments, the third conductive member 104 may be provided with two third pins 1043, and the fourth conductive member 105 may be provided with two fourth pins 1053. The two third pins 1043 may be respectively located on two sides of a third opening 1042, and the two fourth pins 1053 may be respectively located on two sides of a fourth opening 1052. The third conductive member 104 and the fourth conductive member 105 are part of the secondary winding of the magnetic assembly. The third pins 1043 and the fourth pins 1053 may be respectively connected with the first pins 1013 of the first conductive member 101 and the second pins 1023 of each of the one or more skeletonless windings to connect these conductive members in parallel. In some embodiments, the third conductive member 104 and the fourth conductive member 105 may be copper sheets.

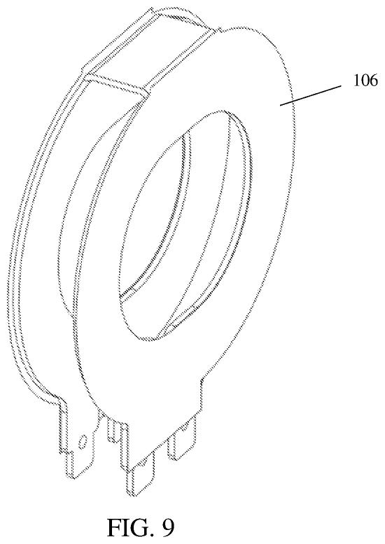

In some embodiments, in order to prevent the magnetic component from short circuiting, outer side of all of the first conductive member 101, the second conductive member 102, the resisting part 103, the third conductive member 104, and the fourth conductive member 105 may be provided with a first insulating layer 106 as shown in FIG. 9, and the coils in each of the winding assemblies 30 are also provided with a second insulating layer. Each of the winding assemblies 30 may be formed by winding three layers of coils with the second insulating layer on the winding post(s).

In some embodiments, as shown in FIG. 5 and FIG. 6, the magnetic core assembly further includes a first magnetic core part 201a and a second magnetic core part 201b fixedly connected to the first magnetic core part 201a.

In some embodiments, the first magnetic core part 201a and the second magnetic core part 201b are symmetrical. The first magnetic core part 201a, the second magnetic core part 201b, and the winding posts may form a magnetic core in the magnetic assembly. The first magnetic core part 201a and the second magnetic core part 201b can be fixedly connected by dispensing glue.

In an embodiment shown in FIG. 5 and FIG. 6, the magnetic core assembly may be composed of two E-shaped magnetic cores. That is, a first winding post 202a and the first magnetic core part 201a are integrally formed to form one E-shaped magnetic core, and a second winding post 202b and the second magnetic core part 201b are integrally formed to form one E-shaped magnetic core.

It should be noted that the magnetic core assembly mentioned in this disclosure may also be composed of a U-shaped magnetic core and a T-shaped magnetic core. A structure of the magnetic core assembly may be selected according to actual applications, which will not be limited in this embodiment.

In summary, the skeletonless winding according to embodiments of the present disclosure may be formed by the first conductive member 101, the second conductive member 102, and the resisting part 103. The first conductive member 101 is provided with the first through hole 1011. The second conductive member 102 is provided with the second through hole 1021. The second through hole 1021 is connected with the first through hole 1011 to form the through hole. The resisting part 103 is fixed connected to the first conductive member 101 and the second conductive member 102 to form an integrated structure and to form the cavity between the first conductive element 101 and the second conductive element 102. In this way, in an assembly process of the magnetic component, the one or more winding posts may be arranged inside the through hole, and the one or more winding assemblies 30 may be wound around an outer circumference of the one or more winding posts in the cavity without setting a skeleton in the magnetic component, which may improve an assembly efficiency of the magnetic component, reduce a volume of the magnetic component, and avoid poor heat dissipation performance of a transformer due to addition of the skeleton.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure

What is claimed is:

1. A skeletonless winding, comprising:
a first conductive element provided with a first through hole;
a second conductive member, provided with a second through hole that is connected with the first through hole to form a through hole; and
a resisting part, fixedly connected between the first conductive element and the second conductive element to form a cavity between the first conductive element and the second conductive element.

2. The skeletonless winding of claim 1, wherein the first conductive member, the second conductive member, and the resisting part are integrally formed.

3. The skeletonless winding of claim 2, wherein outside of the first conductive member, the second conductive member, and the resisting part is provided with a first insulating layer.

4. The skeletonless winding of claim 1, wherein the first conductive member is further provided with a first opening that is connected to the first through hole, and the second conductive member is further provided with a second opening that is connected to the second through hole.

5. The skeletonless winding of claim 4, wherein the first conductive member is further provided with first pins located on two sides of the first opening, and the second conductive member is further provided with second pins located on two sides of the second opening.

6. A magnetic assembly, comprising:
one or more skeletonless windings, each of the one or more skeletonless windings comprising:
a first conductive element provided with a first through hole;
a second conductive member, provided with a second through hole that is connected with the first through hole to form a through hole; and
a resisting part, fixedly connected between the first conductive element and the second conductive element to form a cavity between the first conductive element and the second conductive element;
a magnetic core assembly comprising one or more winding posts arranged inside the through hole; and
one or more winding assemblies wound on an outer peripheral surface of the one or more winding posts in the cavity.

7. The magnetic assembly of claim 6, further comprising a third conductive member and a fourth conductive member,
wherein the third conductive member is provided with a third through hole, and the fourth conductive member is provided with a fourth through hole; the first through hole and the second through hole of each of the one or more skeletonless windings, the third through hole, and the fourth through hole are connected to form a through hole; and the third conductive element and the fourth conductive member are respectively located on two sides of the skeletonless windings.

8. The magnetic assembly of claim 6, wherein each of the one or more winding assemblies comprise pancake windings generated by winding three layers of coils.

9. The magnetic assembly of claim 6, wherein the magnetic core assembly further comprises a first magnetic core part and a second magnetic core part fixedly connected to the first magnetic core part.

10. The magnetic assembly of claim 9, wherein the one or more winding posts comprise a first winding post and a second winding post, the first winding post and the first magnetic core part are integrally formed, and the second winding post and the second magnetic core part are integrally formed.
